(19) United States
(12) Patent Application Publication
(10) Pub. No.: US 2015/0228059 A1
(43) Pub. Date: Aug. 13, 2015

(54) METHOD FOR SEMANTIC IMAGE ENHANCEMENT

(71) Applicant: OCE-TECHNOLOGIES B.V., Venlo (NL)

(72) Inventors: Nicolas P.M.F. BONNIER, Mosman (AU); Albrecht J. LINDNER, Lausanne (CH); Sabine SUSSTRUNCK, Lausanne (CH)

(73) Assignee: OCE-TECHNOLOGIES B.V., Venlo (NL)

(21) Appl. No.: 14/695,694

(22) Filed: Apr. 24, 2015

Related U.S. Application Data
(63) Continuation of application No. PCT/EP2013/072432, filed on Oct. 25, 2013.

(30) Foreign Application Priority Data
Oct. 26, 2012 (EP) 12306331.5

(51) Int. Cl. G06T 5/00; G06T 11/20

(52) U.S. Cl. CPC G06T 5/002; G06T 11/20

(57) ABSTRACT

The invention is related to a method for image processing a raster image according to an amount of image enhancement, using an image keyword. A predetermined set of raster images with associated keywords is used, a raster image being a digital image with pixel values. The invented method comprises the steps of determining an image property, which is a value derivable from the values of the pixels of a raster image, obtaining from the set of raster images a plus set, which comprises raster images that are associated with said image keyword and a minus set, which comprises raster images that are not associated with said image keyword, obtaining a difference value between the image property of the raster image and a reference value from the set of image properties of the images of the plus set, obtaining a significance value for the image keyword by comparing the image properties of images of the plus set with the image properties of images of the minus set, determining the amount of image enhancement in dependence of said difference value and said significance value, and processing the raster image according to the determined amount of image enhancement. Thus, an image keyword is used as a second, independent input, besides the input of the pixel values of the raster image, to control the image enhancement, which increases the flexibility of the dependence of the amount of automatic image enhancement on the keyword that a user selects to indicate his intention in relation to the input raster image.

### FIELD OF THE INVENTION

The invention relates to a method for determining an amount of image enhancement for image processing a raster image, using an image keyword and a predetermined set of raster images with associated keywords, a raster image being a digital image with pixel values. The invention further relates to a computer program product for executing the invented method and a print system for processing image data for reproduction.

### BACKGROUND OF THE INVENTION

Image processing algorithms are universally applied to improve the presentability of images. Raster images, having pixels with digital values, are very convenient for image processing according to a user's preference, since pixel values may be modified by any function depending on the values of the pixel and its direct surrounding. Image processing algorithms include contrast enhancement, colour amendment, sharpening, blurring etc. Depending on the content of the image, an amount in which an algorithm is applied, may be selected. In this way the image processing may be tuned to the appropriate application of the image.

However, with the increasing number of possibilities, the plethora of choices to select from also increases, leaving a less experienced user of a system to reproduce an image lost in the alternatives. Therefore, procedures to select an algorithm and its amount of application have been devised to assist a user of a system for reproducing images. These automatic image enhancement procedures usually determine properties of a raster image, a property being a value derivable from the values of the pixels of a raster image, and apply one or more algorithms to bring these properties in a preferred range of values. This preferred range of values may depend on a classification of images, which is also derived from its pixel values.

Another branch of image processing deals with the retrieval of images by the use of semantic concepts, or image keywords. In this branch it is customary to use a large set of images with associated keywords in order to devise a way to automatically link a new image with a semantic class, based on the properties of the image. Large sets of images with keywords associated by human observers are publicly available for research purposes.

The existing methods for automatic image enhancement of a raster image all depend on the pixel values of the image. Hence, one input image will give a predefined output image. Depending on the purpose of rendering an input image, it is known to adapt the automatic image processing according to an image class associated with an image, but the available variation of pre-selected classes is rather limited in view of the large variety of semantic concepts that are applicable to images. Therefore a problem exists in the flexibility to accommodate an amount of automatic image enhancement to a variety of keywords that a user may associate with an image. An object of the present invention is to overcome this limited flexibility.

### SUMMARY OF THE INVENTION

According to the present invention, the above mentioned object is achieved by a method for image processing a raster image according to an amount of image enhancement, using an image keyword and a predetermined set of raster images with associated keywords, the method comprising the steps of determining an image property, which is a value derivable from the values of the pixels of a raster image, obtaining from the set of raster images a plus set, which comprises raster images that are associated with said image keyword and a minus set, which comprises raster images that are not associated with said image keyword, obtaining a difference value between the image property of the raster image and a reference value from the set of image properties of the images of the plus set, obtaining a significance value for the image keyword by comparing the image properties of images of the plus set with the image properties of images of the minus set, determining an amount of image enhancement in dependence of said difference value and said significance value and processing the raster image according to the determined amount of image enhancement. In this way an image keyword is used as a second independent input, besides the input of the pixel values of the raster image, to control the image enhancement. It is noted that the image keyword may be selected independently from the raster image to enhance an aspect of the raster image that the user associates by an image keyword. The effect of this association is obtained from the properties of images in the predetermined set of raster images and their associated keywords. In this way the amount of automatic image enhancement is flexibly dependent on the keyword that a user selects to indicate his intention in relation to the input raster image. Further details are given in the dependent claims.

The present invention further comprises a computer program product, including computer readable code embodied on a computer readable medium, said computer readable code comprising instructions for executing the steps mentioned above.

The present invention also comprises a print system configured to process images for reproduction including an image enhancement module configured to apply a method comprising the steps mentioned above.

The philosophy behind this approach to semantic image enhancement is that it is not possible to optimize the visual appearance of an image based only on the pixel values. For an optimal result, it is indispensable to know its semantic context. Conventional image-statistics based enhancement algorithms such as contrast stretching are not able to do this because they do not take into account the semantic context.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Hereinafter the present invention is further elucidated with references to the appended drawings showing non-limiting embodiments and wherein:

FIG. 1 shows the coherence of a number of elements in the invented method; and

FIG. 2 is a computer configuration for executing the invented method.

### DETAILED DESCRIPTION OF EMBODIMENTS

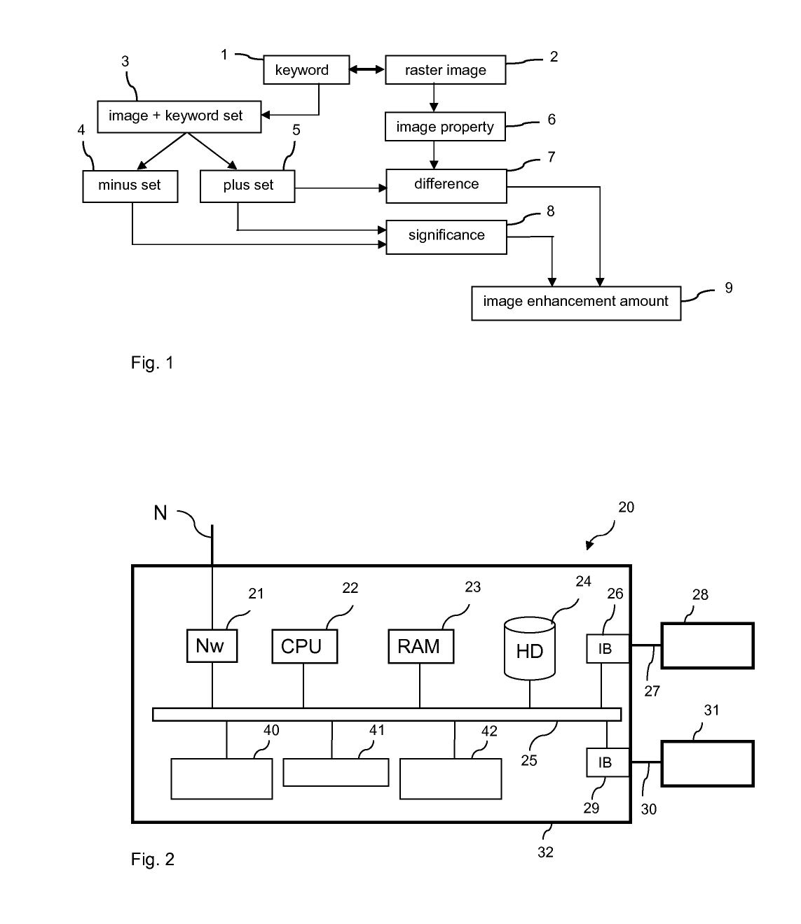

FIG. 1 shows a number of elements that are paramount in the application of the invented method. A keyword 1 is supplied independently from a raster image 2 by a user of the method. By supplying a keyword, a user expresses his intention about or points to an outstanding element in the raster image 2. The keyword 1 is used to obtain from a set of raster images 3, each image being associated with one or more keywords, a minus set 4 and a plus set 5. The images set 3 may comprise data from online image-sharing communities for estimating correspondences between image keywords and characteristics. The keywords in the set 3 are used to determine the relevance of a property of a raster image in the set, a property being a value derivable from the values of the pixels of a raster image. The plus set 5 comprises images with a corresponding keyword, whereas the minus set 4 comprises images that are not associated with the given keyword. An image property 6 is calculated for the raster image 2 and compared to a relevant value of the same image property of each of the images from plus set 5. This relevant value may be a percentile in a statistical distribution of these properties. If a 50th percentile is used, the relevant value is not more than a kind of average value, whereas if a 5th percentile is used, the image property 6 will often be considered very low and therefore will be enhanced too strongly. Using the 25th percentile a good tradeoff between these extremes is obtained. The difference 7 between the relevant value and the image property 6 is one input element for determining the amount of image enhancement 9. A second element is the significance value 8 which indicates the significance of the image property for the keyword. This is derived from a statistical analysis of the image property for images in the plus set 5 and the minus set 4.

This general framework can be used for any application where image characteristics have to be linked to image semantics or keywords 1. In this example we focus on semantic image enhancement, which aims at rerendering an image to adapt to a given semantic context. We define re-rendering as taking as input an image that has been processed in-camera or even enhanced afterwards and that we process to better visually match a semantic concept. The proposed image enhancement is based on two components:

1) the image content as defined by the pixel values
2) the image semantics as described by a keyword.

The first component uses standard image processing techniques. The novelty is the combination with the second component to make the processing semantically adaptive. We use the significance values in order to assess whether changing a characteristic is meaningful and if yes, how it has to be changed for an optimal adaption to the semantic context. The significance values offer great potential to automatize semantic image processing, because they indicate whether a keyword and a characteristic are correlated. Keywords with lower significance values can be automatically discarded (e.g. happy or day for an image of a landscape) as they are not meaningful in terms of image processing. Also, we can automatically detect when images are “wrongly” annotated, i.e. no region in the image has significant characteristics corresponding to a particular keyword.

In the following, we present an example of an image enhancement algorithm of re-rendering for gray levels. In a similar way this method is profitable to re-render the colours in an image or for a very different type of enhancement: altering an image's frequencies in order to create artistic blurring effects that match the image's semantics.

For the first re-rendering application, a gray-level tone mapping curve is computed that accounts for the image's semantic context. It is a global operation that maps an input pixel's gray level to a new gray level in the output image and thus alters the image's gray-level distribution.

To re-render an image for a specific semantic concept, its characteristic needs to be changed according to the two previously mentioned components: semantic context and image content. Hence we define two conditions that need to be fulfilled in order to alter the gray-level distribution: 1. the characteristic is significant for the semantic concept; 2. the characteristic in the present image is too low or too high for the given concept.

An image will not be altered if the characteristic is not influenced by the keyword or if the image is already a good example for it. The first component is the significance 8 of the semantic concept and is assessed via a standardized z value from:

z=(T−μ_{T})/σ_{T} (1)

wherein T is the ranksum of the set of all image properties of images in plus set 5 and minus set 4, and μᵣ and σ_{T} are an expected mean and variance of the distribution in this set. If the z value is positive, the value of the corresponding characteristic has to be increased, and if the z value is negative, the value of the corresponding characteristic has to be decreased. We assume a linear relationship between the z values and the strength of the image processing; meaning that if the z value's absolute value is k times higher, the processing is k times stronger.

The second component is image dependent. We assess how well the given image already fulfills the desired characteristics for its semantic concept. We compare the image's characteristics to the characteristics of all images with the same keyword, the plus set 5. Therefore, we compute the difference 7 to a percentile of the distribution in the set of image properties of the plus set 5. If we use the 50th percentile to compute the difference 7, it is zero if the input raster image's 2 characteristic property is average for its semantic concept. If, however, we want to emphasize the significant characteristics more, a lower percentile has to be chosen. We found that a 25th percentile is a good tradeoff between a desired enhancement and an extreme overshooting, which would happen for percentiles in the order of the 5^{th} percentile.

Similarly to the dependency on the z values, we implement a linear relationship between the difference values and the strength of the enhancement. Thus, the image processing has to be proportional to the product of the significance z and difference values. An image property is a value represented by an n-tuple, in this case a 16-tuple for a histogram of pixel values.

We use the significance value z from Equation 1 and the difference value δ to determine a tone-mapping of an image's gray levels. According to our previous assumptions, the product zδ is proportional to the change a processing introduces to an image. In the case of a tone-mapping function, the strength is given by its slope. If at gray-level g, the slope is m(g), the pixels in the interval around g are redistributed to a graylevel interval of m(g) times the size. This holds for m>1 (decreasing density) as for m<1 (increasing density). A slope equal to one is the identity transform. As the zδ value indicates how strongly a characteristic has to be altered, the slope is:

m=1/(1+Szδ) if zδ≧0

1+S|zδ| if zδ<0 (2)

where S is a proportionality constant that controls the overall strength of the tone mapping. Extreme slope values are not desirable. A very steep mapping increases quantization artefacts and noise in homogeneous areas, and a very flat mapping reduces local contrast. Thus, the slope is cropped to a range [1/mₘₐₓ mₘₐₓ]. This is an inherent problem for any tone-mapping applications and not specific to this approach. We used mₘₐₓ=5, which is a good compromise between limiting extreme tone mappings and allowing visible changes.

The slope values from Equation 2 are linearly interpolated for 256 values in the interval [0 255] by using the representative mean gray level of each characteristic. Because these values specify the slope, they are the derivative of the tone mapping function. An integration thus yields the desired function.

Due to the continuity of the slope values, the mapping function is continuous and differentiable. This guarantees a certain smoothness constraint that is beneficial for noninvasive processing. In a final step, we scale the mapping function to the interval [0 255] in order to maintain the image's black and white points. Different proportionality constants S may be used. The smaller the S is, the closer the mapping function is to the identity transform. Higher S values lead to a more extreme mapping. Typically S=0.5 or S=2.

In FIG. 2 a print system 20 is shown, comprising a controller 32 and two print engines 28 and 31. Dedicated interface boards 26 and 29, connected to a system bus 25 provide the print engines with print data through connections 27 and 30. The controller comprises a network board 21 for connecting the controller to a network N, a central processing unit 22, a volatile memory 23 and a non-volatile memory 24. Also connected to the system bus 25 are data-base module 40, comprising a large data-base of raster images with associated keywords, image enhancement amount module 41, that determines a parameter from a significance of the keyword for an image property and from a difference of the image property of the raster image and the image property of images with a similar keyword. This parameter is passed to image enhancement module 42, to adapt the amount of image enhancement for the raster image that is to be printed.

The above disclosure is intended as merely exemplary, and not to limit the scope of the invention, which is to be determined by reference to the following claims.

What is claimed is:

1. A method for image processing a raster image according to an amount of image enhancement, using an image keyword and a predetermined set of raster images with associated keywords, a raster image being a digital image with pixel values, the method comprising the steps of:
a) determining an image property, which is a value derivable from the values of the pixels of a raster image;
b) obtaining from the set of raster images a plus set, which comprises raster images that are associated with said image keyword and a minus set, which comprises raster images that are not associated with said image keyword;
c) obtaining a difference value between the image property of the raster image and a reference value from the set of image properties of the images of the plus set;
d) obtaining a significance value for the image keyword by comparing the image properties of images of the plus set with the image properties of images of the minus set;
e) determining the amount of image enhancement in dependence of said difference value and said significance value; and
f) processing the raster image according to the determined amount of image enhancement.

2. The method according to claim 1, wherein the reference value of step c) is in the neighbourhood of the 25th percentile of the set of image properties of the images of the plus set.

3. The method according to claim 1, wherein the predetermined set of raster images is varied according to a specific algorithm used for enhancing the raster image.

4. The method according to claim 1, wherein a tone transfer curve is derived in accordance with the amount of image enhancement.

5. The method according to claim 1, wherein an amount of position dependent blurring is derived in accordance with the amount of image enhancement.

6. A computer program product, including computer readable code embodied on a computer readable medium, said computer readable code comprising instructions for executing the steps of the method of claim 1.

7. A print system configured to process image data for reproduction including a colour conversion module configured to use an output profile according to the method of claim 1.
